(19) United States
(12) Patent Application Publication
(10) Pub. No.: US 2026/0006141 A1
(43) Pub. Date: Jan. 1, 2026

(54) IMAGE-FORMING APPARATUS

(71) Applicant: CANON KABUSHIKI KAISHA, Tokyo (JP)

(72) Inventor: MASATO FURUKAWA, Chiba (JP)

(21) Appl. No.: 19/240,826

(22) Filed: Jun. 17, 2025

(30) Foreign Application Priority Data
Jun. 28, 2024 (JP) 2024-105475

(51) Int. Cl. H04N 1/00

(52) U.S. Cl. CPC H04N 1/00819; H04N 1/00811; H04N 1/00824; H04N 2201/0005; H04N 2201/0094

(57) ABSTRACT

An image-forming apparatus includes an image-forming unit; a calibration unit configured to execute calibration of the image-forming unit on the basis of a chart image formed by the image-forming unit; a reading unit configured to generate a read image including the chart image by reading, according to at least one reading condition, a sheet on which the chart image is formed while conveying the sheet along a conveyance path; and a control unit configured to determine, on the basis of the read image, whether the sheet has been correctly read by the reading unit. The control unit is configured to output a notification prompting a user to adjust the at least one reading condition in a case where it is determined that the sheet has not been correctly read by the reading unit.

### BACKGROUND

### Field of the Technology

The present disclosure relates to an image-forming apparatus.

### Description of the Related Art

A technique is known in which an image-forming apparatus forms a known chart image on a sheet, reads the sheet using a scanner, and determines image misalignment or the like in order to calibrate parameters such as the positions in which images are formed on sheets. For example, Japanese Patent Laid-Open No. 2023-118056 discloses a technique for including, in a chart image, a marker that has sides which are not parallel to any sides of a sheet. Using the chart image described in Japanese Patent Laid-Open No. 2023-118056 makes it possible to accurately detect a target marker and calibrate the image-forming apparatus even when the read image includes band-shaped noise.

A scanner of the image-forming apparatus disclosed in Japanese Patent Laid-Open No. 2023-118056 includes an auto document feeder (ADF). When a user places a sheet on which a chart image for calibration has been formed in a document tray, the scanner reads the sheet, which has been conveyed automatically by the ADF, and the calibration is performed on the basis of the read image. However, abnormalities such as misalignment or skewing of the sheet are likely to occur in the reading process.

Japanese Patent Laid-Open No. 2007-329929 discloses a technique in which when an abnormality is determined to have occurred when automatically conveying a sheet for calibration, a user is instructed to reload the sheets in the document tray and attempt the reading again.

### SUMMARY

Components such as conveyance rollers and reading sensors of a scanner equipped with an ADF have specific variations in their characteristics, including attachment tolerances. Adjustment of reading conditions for reducing the effects of such variation (e.g., physical adjustments made using adjustment screws, adjusting setting values such as the start-reading position and the rotation speed of the motor) is normally performed at the factory before the product is shipped. However, deterioration of components over time, vibrations, impacts, or excessive loads when transporting the apparatus, and the like may cause the characteristics of the components to deviate from their normal ranges. If such deviation occurs, the abnormalities will not be resolved even if the user reloads the sheet in the document tray and attempts the reading again. As such, the correct parameter values for calibration will not be obtained, and the calibration of the image-forming apparatus will fail.

In light of the foregoing, the present disclosure provides a mechanism that can facilitate optimization of sheet reading conditions for calibration and prevent calibration failures in an image-forming apparatus.

According to one aspect, there is provided an image-forming apparatus including: an image-forming unit; a calibration unit configured to execute calibration of the image-forming unit on the basis of a chart image formed by the image-forming unit; a reading unit configured to generate a read image including the chart image by reading, according to at least one reading condition, a sheet on which the chart image is formed while conveying the sheet along a conveyance path; and a control unit configured to determine, on the basis of the read image, whether the sheet has been correctly read by the reading unit, wherein the control unit is configured to output a notification prompting a user to adjust the at least one reading condition in a case where it is determined that the sheet has not been correctly read by the reading unit.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram illustrating an example of a configuration of an image-forming apparatus according to an embodiment.

FIG. 2 is a schematic diagram illustrating an example of a configuration of a scanner according to an embodiment.

FIG. 3A is a block diagram illustrating an example of a configuration of a printer control unit.

FIG. 3B is a block diagram illustrating an example of a configuration of a scanner control unit.

FIG. 3C is a block diagram illustrating an example of a configuration of a controller.

FIG. 4 is an explanatory diagram illustrating an example of a configuration of a chart.

FIG. 5 is an explanatory diagram illustrating measurement for an image-forming position based on a chart image.

FIGS. 6A to 6D are explanatory diagrams illustrating determination of an abnormality related to a start-reading position.

FIGS. 7A to 7D are explanatory diagrams illustrating determination of an abnormality related to scanning magnification.

FIGS. 8A and 8B are other explanatory diagrams illustrating determination of an abnormality in a chart image.

FIG. 9 is an explanatory diagram illustrating an example of a configuration of a first notification screen.

FIG. 10 is an explanatory diagram illustrating an example of a configuration of an ADF adjustment screen.

FIGS. 11A and 11B are explanatory diagrams illustrating determination of an abnormality in a chart image that cannot be resolved by adjustments made through user operations.

FIG. 12 is an explanatory diagram illustrating an example of a configuration of a second notification screen.

FIGS. 13A and 13B are explanatory diagrams illustrating determination of an abnormality in a chart image caused by a mistake made during work.

FIG. 14 is an explanatory diagram illustrating an example of a configuration of a third notification screen.

FIG. 15 is a flowchart illustrating an example of an overall flow of calibration processing according to an embodiment.

FIG. 16A is the first half of a flowchart illustrating, in detail, an example of a flow of adjustment determination processing according to an embodiment.

FIG. 16B is the second half of a flowchart illustrating, in detail, an example of the flow of adjustment determination processing according to an embodiment.

FIG. 17 is a flowchart illustrating, in detail, an example of a flow of notification processing according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. Apparatus Overview

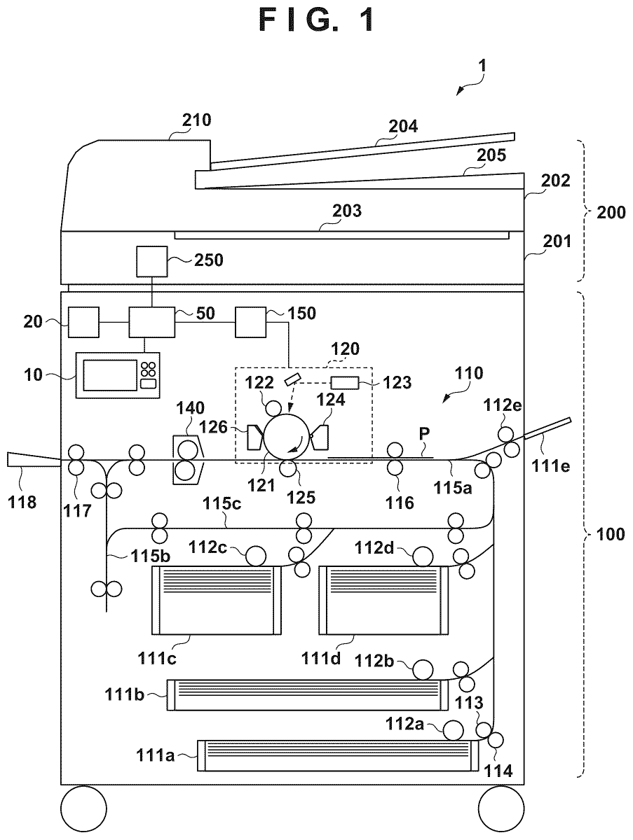

This section will describe an overview of an image-forming apparatus 1 as an example of an apparatus to which the technology according to the present disclosure can be applied. FIG. 1 is a schematic diagram illustrating an example of a configuration of the image-forming apparatus 1 according to an embodiment. In the example illustrated in FIG. 1, the image-forming apparatus 1 is what is known as a multifunction peripheral. The image-forming apparatus 1 includes an operation unit 10, a communication interface 20, a controller 50, a printer 100, and a scanner 200.

### 1-1. Operation Unit

The operation unit 10 is a unit that provides a user interface (UI) to a user of the image-forming apparatus 1. The operation unit 10 includes input devices such as a touch panel, buttons, and switches, and output devices such as a display, a light, and a speaker.

### 1-2. Communication Interface

The communication interface 20 is a communication unit for the image-forming apparatus 1 to communicate with other apparatuses. The communication interface 20 may be a wired communication interface or a wireless communication interface.

### 1-3. Controller

The controller 50 is a control unit that controls the overall functions of the image-forming apparatus 1. In response to instructions input through the operation unit 10 or the communication interface, the controller 50 works in cooperation with a printer control unit 150 of the printer 100 and a scanner control unit 250 of the scanner 200 to control execution of various jobs. For example, if a copy job is instructed to be performed, the controller 50 causes the scanner 200 to read a document, and controls the printer 100 to form an image on a sheet on the basis of read image data generated by the scanner control unit 250. If a print job is instructed to be performed, the controller 50 controls the printer 100 to form an image on a sheet on the basis of print image data received via the communication interface. If a scan job is instructed to be performed, the controller 50 causes the scanner 200 to read a document, store read image data generated by the scanner control unit 250 in internal storage, or send the read image data to an external apparatus via the communication interface. Specific examples of the configurations of the controller 50, the printer control unit 150, and the scanner control unit 250 will be given below.

### 1-4. Printer

The printer 100 is an image-forming unit that forms an image on a sheet (also called a “recording medium”). The present embodiment will mainly describe an example in which the printer 100 forms monochromatic images through an electrophotographic method. However, the technology according to the present disclosure is not limited to this example, and can be applied in an image-forming apparatus that forms color images (e.g., through an offset printing method). The technology according to the present disclosure can also be applied in an image-forming apparatus that operates through another image forming method, such as an ink jet method. The printer 100 includes a conveyance unit 110, an image-forming unit 120, a fixing unit 140, and the printer control unit 150.

The conveyance unit 110 includes cassettes 111a to 111d, a manual feed tray 111e, a variety of rollers involved in feeding and conveying sheets, conveyance paths 115a to 115c, and a discharge tray 118. The cassettes 111a to 111d are container that can contain bundles of sheets of sizes different from one another. Pickup rollers 112a to 112d pick up sheets from the bundles of sheets contained in the corresponding cassettes 111a to 111d, and feed the sheets to the conveyance path 115a. A feed roller 112e feeds a sheet placed in the manual feed tray 111e to the conveyance path 115a. A feed roller 113 and a retarder roller 114 separate sheets to be fed one at a time to prevent the sheets from being fed in multiple. A registration roller pair 116 stops the front edge of a sheet P that is conveyed thereto, corrects skew in the sheet P, and then feeds the sheet P to a transfer position in synchronization with the operation of the image-forming unit 120 (described below).

The image-forming unit 120 includes a photosensitive drum 121, a charger 122, an exposure unit 123, a developer 124, a transfer roller 125, and a cleaner 126. The photosensitive drum 121 is an image carrier capable of rotating in what is the clockwise direction in the figure. The charger 122 uniformly charges the surface of the photosensitive drum 121. The exposure unit 123 exposes the surface of the photosensitive drum 121 with a laser beam in accordance with image data input from the printer control unit 150, and forms an electrostatic latent image on the surface of the photosensitive drum 121. The developer 124 contains a developing agent (e.g., a two-component developing agent including toner and a carrier), and develops the electrostatic latent image to form a toner image by supplying the developing agent to the surface of the photosensitive drum 121. A bias voltage is applied to the transfer roller 125, which then transfers the toner image on the surface of the photosensitive drum 121 to the sheet P that has reached the transfer position. The sheet P onto which the toner image has been transferred is further conveyed to the fixing unit 140, which is disposed downstream from the transfer position. The cleaner 126 removes toner remaining on the surface of the photosensitive drum 121.

The fixing unit 140 is a unit that fixes the toner image onto the sheet P. The toner of the toner image melts by being heated by a heating roller of the fixing unit 140, and adheres to the sheet by being pressurized by a pressurizing roller. A roller pair in the fixing unit 140 conveys the sheet P further downstream by nipping the sheet P. A discharge roller pair 117 discharges the sheet P on which the image formation is complete to the discharge tray 118.

When double-sided printing is performed, a toner image is formed on a first surface of the sheet P, and the sheet P is conveyed to the conveyance path 115b. The travel direction of the sheet P is reversed in the conveyance path 115b. The sheet P passes through a double-sided conveyance path 115c, and returns to the conveyance path 115a having been flipped. When the sheet P reaches the transfer position again, a toner image is transferred to a second surface of the sheet P. The fixing unit 140 heats and pressurizes the sheet P again to fix that toner image onto the second surface. The sheet P is then discharged to the discharge tray 118.

### 1-5. Scanner

The scanner 200 is a reading unit that generates a read image by reading a document. In the present embodiment, the scanner 200 is constituted by a main body 201 and a cover 202. The cover 202 is connected to the main body 201 by a hinge, and can be opened and closed. When the user opens the cover 202, a document platform 203 on the top surface of the main body 201 is exposed. The cover 202 includes an ADF 210 (described below). The document to be read by the scanner 200 is placed on the document platform 203 or set in a document tray 204 by a user. The ADF 210 conveys the document set in the document tray 204 along an internal conveyance path and discharges the document to a discharge tray 205. A line sensor 225 (described below) optically reads a document placed on the document platform 203 or a document conveyed by the ADF 210. A more detailed example of the scanner 200 will be described further in the next section.

### 2. Detailed Configuration of Scanner

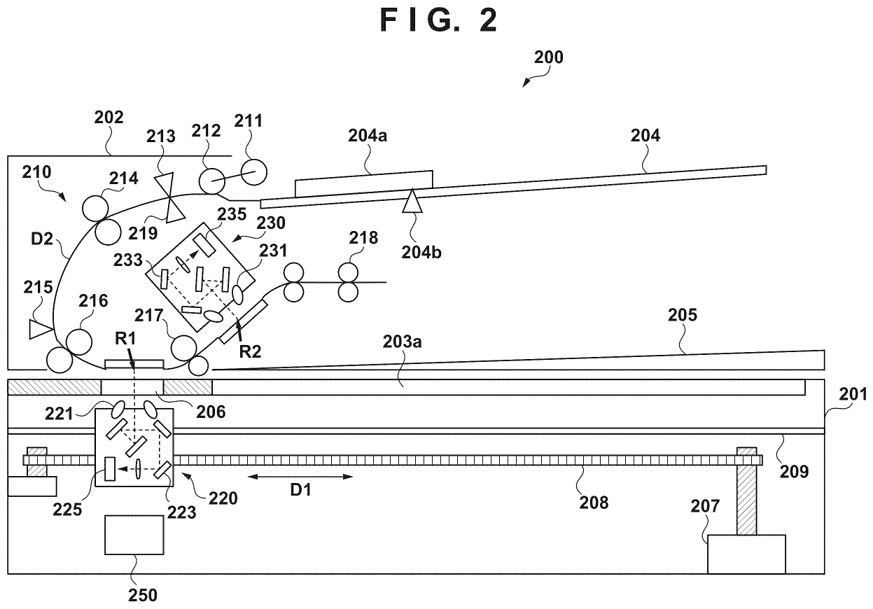

FIG. 2 is a schematic diagram illustrating an example of a configuration of the scanner 200 according to an embodiment. Referring to FIG. 2, the main body 201 includes a document platform glass 203a, a flow reading glass 206, a motor 207, a timing belt 208, a guide 209, a first reading unit 220, and the scanner control unit 250. The cover 202 includes the document tray 204, the discharge tray 205, the ADF 210, and a second reading unit 230. The document tray 204 includes a pair of regulating plates 204a and a width sensor 204b. The ADF 210 is disposed along a conveyance path D2, and includes a variety of rollers and sensors involved in conveying the document.

When reading a document placed on the document platform glass 203a, the scanner control unit 250 causes the motor 207 to rotate. The timing belt 208 transmits driving force of the motor 207 to the first reading unit 220, and the first reading unit 220 moves along the guide 209 in a sub scanning direction (a direction D1 in the figure). The first reading unit 220 includes an illumination unit 221, an optical system 223, and the line sensor 225. The illumination unit 221 may include, for example, one or more light-emitting diodes (LEDs), and emits light onto a document. The optical system 223 includes a plurality of lenses and mirrors, and forms light reflected by the first surface (a front surface) of the document into an image on a light-receiving surface of the line sensor 225. The line sensor 225 is a group of image sensors that are disposed on a pixel-by-pixel basis along a main scanning direction (the depth direction, in the figure). Here, the image sensor may be a photoelectric conversion element such as a Charge Coupled Device (CCD), for example. Alternatively, a Contact Image Sensor (CIS) may be used instead of a CCD. The line sensor 225 reads the light from the first surface of the document one line at a time while the first reading unit 220 is moving in a sub scanning direction, and generates a read image of the first surface.

When setting one or more sheets of a document in the document tray 204, the user adjusts the positions of the regulating plates 204a such that the spacing between the regulating plates 204a conforms to the width of the document in the main scanning direction. The width sensor 204b detects the spacing between the regulating plates 204a as the width of the document. When reading a document sheet conveyed by the ADF 210, the scanner control unit 250 drives a conveyance motor (not shown) to rotate rollers in the ADF 210. A pickup roller 211 contacts the top surface of the bundle of document sheets and feeds one sheet of the document at a time into a conveyance path D2. A separation roller 212 separates the fed document sheet from the remaining document sheets.

A separation sensor 213 detects a front edge and a rear edge of the document conveyed along the conveyance path D2. The length of the document can be determined from a difference between the timings at which the separation sensor 213 detects the front edge and the rear edge of the document. The front edge of the document is pressed against a nip position of a registration roller pair 214, which corrects skew in the document. The registration roller pair 214 conveys the document further downstream toward a first reading position R1. A lead sensor 215 is disposed downstream of the registration roller pair 214. The lead sensor 215 detects the front edge of the document. The scanner control unit 250 determines the timing at which the first reading unit 220 (and the second reading unit 230) is to start reading the document on the basis of the timing at which the lead sensor 215 detects the front edge of the document. A skew sensor 219 is also disposed in the vicinity of the separation sensor 213. The skew sensor 219 detects the extent of skew (an angle with respect to the conveyance direction) of the document being conveyed.

A first lead roller pair 216 feeds the document to the first reading position R1. The flow reading glass 206 is provided below the first reading position R1, and the first reading unit 220 is located below the flow reading glass 206. The line sensor 225 of the first reading unit 220 reads the light emitted from the illumination unit 221 and then reflected by the first surface of the document, one line at a time, while the document passes through the first reading position R1, and generates a read image of the first surface. A second lead roller pair 217 then feeds the document to a second reading position R2.

The second reading unit 230 is located above the second reading position R2. Both the first reading unit 220 and the second reading unit 230 read the document when both sides of the document are instructed to be read. The second reading unit 230 includes an illumination unit 231, an optical system 233, and a line sensor 235. The illumination unit 231 may include, for example, one or more LEDs, and emits light onto the document. The optical system 233 includes a plurality of lenses and mirrors, and forms light reflected by the second surface (a back surface) of the document into an image on a light-receiving surface of the line sensor 235. The line sensor 235 is a group of image sensors that are disposed on a pixel-by-pixel basis along the main scanning direction. The line sensor 235 reads the light reflected by the second surface of the document, one line at a time, while the document passes through the second reading position R2, and generates a read image of the second surface. The document that has passed through the second reading position R2 is discharged to the discharge tray 205 by a discharge roller pair 218.

The photoelectric conversion elements on the light-receiving surfaces of the line sensor 225 of the first reading unit 220 and the line sensor 235 of the second reading unit 230 convert received light into electrical signals, and the electrical signals become analog image signals that represent the read image. The line sensors 225 and 235 are implemented on corresponding sensor substrates (not shown). The analog image signals are output from the sensor substrates to the scanner control unit 250, and are converted into read image data in digital format by an analog-digital conversion unit (ADC) 259 (described below).

### 3. Configuration of Control Functions

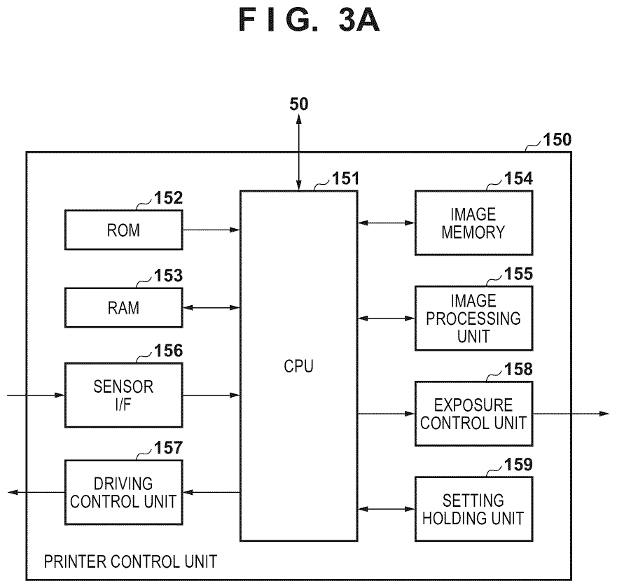

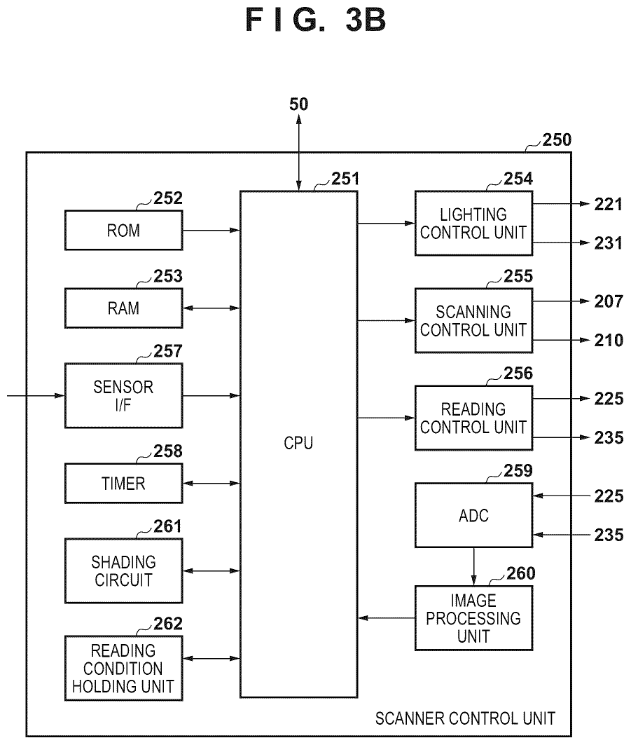

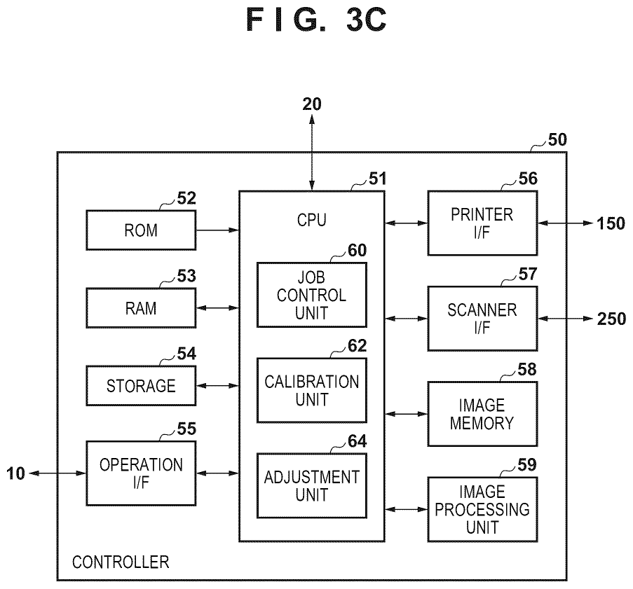

This section will describe an example of a configuration related to control functions of the image-forming apparatus 1, with reference to FIGS. 3A to 3C.

### 3-1. Printer Control Unit

FIG. 3A is a block diagram illustrating an example of a configuration of the printer control unit 150. The printer control unit 150 includes a central processing unit (CPU) 151, a read-only memory (ROM) 152, a random access memory (RAM) 153, an image memory 154, an image processing unit 155, a sensor I/F 156, a driving control unit 157, an exposure control unit 158, and a setting holding unit 159.

The CPU 151 controls image-forming operations of the printer 100 by executing control programs stored in the ROM 152. The CPU 151 is connected to the controller 50 over a signal line. The RAM 153 provides a temporary storage region for operations to the CPU 151. The image memory 154 is a memory that stores input image data. The image processing unit 155 executes image processing such as rasterization, gamma correction, and binarization on the input image data before executing a job.

The sensor interface (I/F) 156 is an interface for connecting various sensors provided in the printer 100 to the CPU 151. For example, the sensor I/F 156 obtains a sheet detection signal, which indicates the presence or absence of a sheet and the size of the sheet, from sheet sensors disposed in the cassettes 111a to 111d, and outputs the obtained sheet detection signal to the CPU 151. The driving control unit 157 controls the driving of various actuators (e.g., motors and clutches) provided in the printer 100. The exposure control unit 158 controls the exposure of the photosensitive drum 121 by the exposure unit 123 in accordance with the input image data processed by the image processing unit 155.

The setting holding unit 159 holds various settings for image-forming operations. For example, the setting holding unit 159 holds setting values, such as those listed below, related to calibration of the image-forming position:
offset of a start-writing position in the main scanning direction (in pixels)
offset of a start-writing position in the sub scanning direction (in pixels)
magnification in the main scanning direction (%)
magnification in the sub scanning direction (%)
   These setting values may be held separately for the image-forming operations performed for the first surface of the sheet and the image-forming operations performed for the second surface. The driving control unit 157 and the exposure control unit 158 adjust the image-forming position on the sheet, in the main scanning direction and the sub scanning direction, in accordance with the setting values held in the setting holding unit 159. For example, an exposure start position on the surface of the photosensitive drum 121 may be offset, or an exposure range may be enlarged or reduced.

### 3-2. Scanner Control Unit

FIG. 3B is a block diagram illustrating an example of a configuration of the scanner control unit 250. The scanner control unit 250 includes a CPU 251, a ROM 252, a RAM 253, a lighting control unit 254, a scanning control unit 255, a reading control unit 256, a sensor I/F 257, a timer 258, the ADC 259, an image processing unit 260, a shading circuit 261, and a reading condition holding unit 262.

The CPU 251 controls reading operations of the scanner 200 by executing control programs stored in the ROM 252. The CPU 251 is connected to the controller 50 over a signal line. The RAM 253 provides a temporary storage region for operations to the CPU 251.

The lighting control unit 254 controls the lighting of the illumination unit 221 of the first reading unit 220 and the illumination unit 231 of the second reading unit 230. The scanning control unit 255 controls the movement of the first reading unit 220 in the direction D1 and the conveyance of the document along the conveyance path D2 of the ADF 210. The reading control unit 256 controls the reading of the first surface of the document by the line sensor 225 of the first reading unit 220 and the reading of the second surface of the document by the line sensor 235 of the second reading unit 230.

For example, when reading a document placed on the document platform glass 203a, the scanning control unit 255 controls the driving of the motor 207 such that the first reading unit 220 moves in the sub scanning direction at a predetermined movement speed. The lighting control unit 254 causes the illumination unit 221 to irradiate the first surface of the document with light while the first reading unit 220 moves under the document platform glass 203a. The reading control unit 256 causes the line sensor 225 to read each line of the first surface of the document at an interval corresponding to a designated reading resolution.

During flow reading, the scanning control unit 255 controls the driving of a motor connected to the rollers of the ADF 210 such that the rollers of the ADF 210 conveys the document along the conveyance path D2 at an appropriate timing. The lighting control unit 254 causes the illumination unit 221 to irradiate the first surface of the document with light while the document passes through the first reading position R1. The reading control unit 256 causes the line sensor 225 to read each line of the first surface of the document at the timing at which each line passes through the first reading position R1. In addition, when both sides are instructed to be read, the lighting control unit 254 causes the illumination unit 231 to irradiate the second surface of the document with light while the document passes through the second reading position R2. The reading control unit 256 causes the line sensor 235 to read each line of the second surface of the document at the timing at which each line passes through the second reading position R2.

The sensor I/F 257 is an interface for connecting various sensors included in the scanner 200 to the CPU 251. For example, during flow reading, the CPU 251 can determine the size of the document, i.e., the width and length of the document, on the basis of the sensor signals input from the width sensor 204b and the separation sensor 213. Note that instead of determining the size of the document on the basis of the sensor signals, the CPU 251 may determine the size of the document on the basis of user input obtained through the operation unit 10.

The CPU 251 can also determine when the line sensors 225 and 235 are to perform the reading on the basis of a document detection signal input from the lead sensor 215. The timer 258 is used to measure the times from when the lead sensor 215 detects the front edge of the document to when the front edge of the document reaches the first reading position R1 and the second reading position R2. For example, the timer 258 may count pulses of a periodic pulse signal that is based on the rotation of the motor involved in conveying the document. The CPU 251 can determine the distance the document has moved along the conveyance path D2 on the basis of the number of pulses counted by the timer 258.

The ADC 259 AD-converts the analog image signals input from the line sensors 225 and 235, and outputs read image data in digital format to the image processing unit 260. The image processing unit 260 performs image processing such as noise removal, resolution conversion, and skew correction on the read image data. The shading circuit 261 performs shading correction on the read image data processed by the image processing unit 260. Although not illustrated in FIG. 3B, the shading circuit 261 may have a memory that stores coefficient sets and target values for shading correction, which are determined in advance according to the characteristics of the first reading unit 220 and the second reading unit 230.

The reading condition holding unit 262 holds at least one reading condition used when the scanner 200 reads a document. For example, the reading conditions held by the reading condition holding unit 262 may include at least one of the following conditions C1 to C6:
C1) a start-reading position in a main scanning direction perpendicular to a conveyance direction of the sheet
C2) a start-reading position in a sub scanning direction parallel to the conveyance direction of the sheet
C3) a scanning magnification in the main scanning direction
C4) a scanning magnification in the sub scanning direction
C5) an amount of light with which the sheet is irradiated
C6) a skew correction amount
   The values of these reading conditions may be held separately for the first reading unit 220 and the second reading unit 230.

For example, the reading control unit 256 may, on the basis of the reading condition C1, determine which positions of which pixels of the line sensors 225 and 235 correspond to the pixels at the left end of the read image. The reading control unit 256 may, on the basis of the reading condition C2, determine a length of time from when the lead sensor 215 detects the front edge of the document to when the line sensors 225 and 235 start reading the first line. The reading control unit 256 may, on the basis of the reading conditions C3 and C4, determine a reading size in the main scanning direction and the sub scanning direction, respectively. The lighting control unit 254 may, on the basis of the reading condition C5, determine the amount of light with which the illumination units 221 and 231 are to irradiate the sheet. The scanning control unit 255 may, on the basis of the reading condition C6, determine a skew correction amount for the document conveyed by the ADF 210.

Typically, the values of the reading conditions C₁ to C₆ are determined through pre-shipment testing in order to reduce the effects of variations in the characteristics among individual apparatuses, and are written to the reading condition holding unit 262. In addition, as will be described in detail below, in the present embodiment, the image-forming apparatus 1 provides an adjustment function for enabling the user to adjust at least one of the reading conditions C1 to C6.

### 3-3. Controller

FIG. 3C is a block diagram illustrating an example of a configuration of the controller 50. The controller 50 includes a CPU 51, a ROM 52, a RAM 53, storage 54, an operation I/F 55, a printer I/F 56, a scanner I/F 57, an image memory 58, and an image processing unit 59.

The CPU 51 provides various functions for controlling execution of jobs by the printer 100 and the scanner 200 by executing control programs stored in the ROM 52. The RAM 53 provides a temporary storage region for operations to the CPU 51. In the present embodiment, the CPU 51 functions as a job control unit 60, a calibration unit 62, and an adjustment unit 64. The job control unit 60 controls the execution of copy jobs, print jobs, and scan jobs in the image-forming apparatus 1 as described above. The calibration unit 62 and the adjustment unit 64 will be described in detail below.

The storage 54 may be a storage device including a non-volatile storage medium, such as a hard disk drive (HDD), for example. The storage 54 can be used, for example, to store read image data generated as a result of a scan job. In addition, in the present embodiment, the storage 54 pre-stores the image data of a chart used to calibrate the printer 100 (described below).

The operation I/F 55 is an interface for connecting the controller 50 to the operation unit 10. The printer I/F 56 is an interface for connecting the controller 50 to the printer control unit 150. The scanner I/F 57 is an interface for connecting the controller 50 to the scanner control unit 250. Note that the printer I/F 56 may be connected to the printer control unit 150 by a control signal line for communicating control signals and a data signal line for communicating image data. The same applies to the scanner I/F 57.

The image memory 58 temporarily stores image data exchanged by the controller 50 with the printer 100, the scanner 200, or an external apparatus. The image processing unit 59 converts the format of the image data depending on the apparatus to which the image data is to be output. The image processing unit 59 may also provide image processing functions such as edge extraction, corner detection, angle determination, skew correction, extraction of chart images from read images, detection of known constituent elements in chart images, and text recognition for the calibration unit 62 and the adjustment unit 64 (described below).

Although this section describes an example in which the controller 50, the printer control unit 150, and the scanner control unit 250 each includes a separate CPU, the control functions mentioned above may be implemented in an integrated manner by a single CPU or a smaller number of CPUs. Additionally, a single control function mentioned here may be implemented by being distributed among two or more CPUs. The same applies to other constituent elements such as the ROMs and RAMs. Furthermore, any functions described herein as being implemented by software may be implemented by dedicated hardware.

### 4. Calibration of Image-Forming Position

In the present embodiment, the CPU 51 functions as the calibration unit 62, which calibrates the position on the sheet where the printer 100 forms an image. When the user has instructed calibration through the UI provided by the operation unit 10, the calibration unit 62 causes the printer 100 to form a chart image on a sheet on the basis of image data stored in the storage 54. Then, when the user sets the sheet on which the chart image has been formed in the document tray 204, the calibration unit 62 operates the ADF 210 to convey the sheet along the conveyance path D2, and causes the scanner 200 to read the sheet. The scanner 200 generates read image data representing a read image including the chart image as a result of the reading. The calibration unit 62 executes the calibration on the basis of the read image data received from the scanner 200.

### 4-1. Example of Configuration of Chart

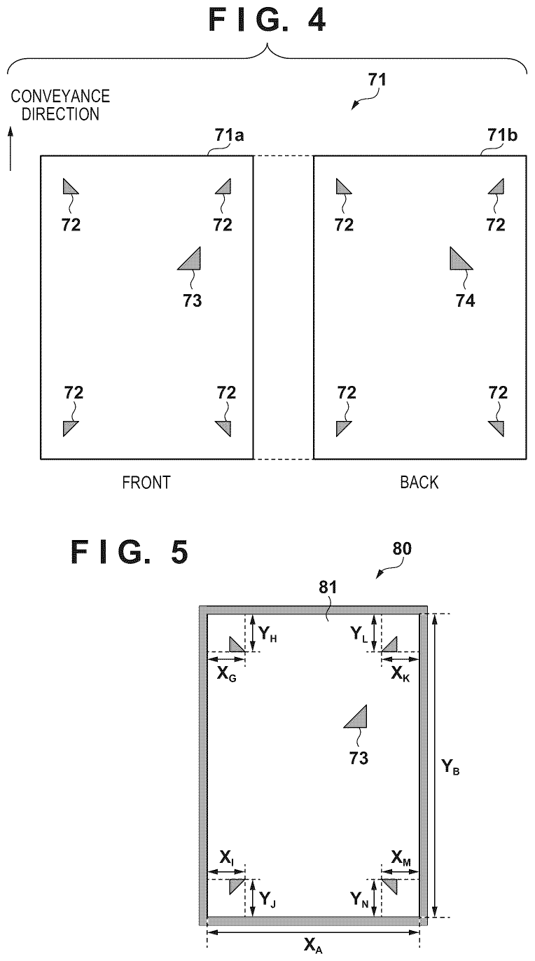

FIG. 4 is an explanatory diagram illustrating an example of a configuration of a chart 71 that can be used by the calibration unit 62. Here, the chart 71 is assumed to have the same configuration as the adjustment chart disclosed in Japanese Patent Laid-Open No. 2023-118056.

In the example in FIG. 4, the chart 71 is constituted by a front-side chart 71a and a back-side chart 71b to enable front and back alignment in double-sided printing. The front-side chart 71a includes four markers 72 and an identification patch 73. The back-side chart 71b includes four markers 72 and an identification patch 74. Each marker 72 is shaped as a right-angled isosceles triangle, with one of the two sides that form the right angle being parallel to the conveyance direction (the sub scanning direction) of the sheet, and the other side being perpendicular to the conveyance direction. Of the two ends of the inclined side, the vertex closer to the center of the chart serves as a reference point for measuring the image-forming position within the sheet. In the front-side chart 71a, the identification patch 73 is located closer to the center of the chart than the four markers 72, but (assuming the conveyance direction is upward) is offset to the upper-right from the center of the chart. Likewise, in the back-side chart 71b, the identification patch 74 is located closer to the center than the four markers 72, but is offset to the upper-right from the center of the chart. The shape of the identification patch 74 in the back-side chart 71b and the shape of the identification patch 73 in the front-side chart 71a are inverted horizontally. The identification patches 73 and 74 are used to identify the front and back, and the orientation, of the chart image.

### 4-2. Measuring Image-Forming Position and Calculating Calibration Parameters

FIG. 5 is an explanatory diagram illustrating measurement for an image-forming position based on the chart image. FIG. 5 illustrates an example of a read image 80 represented by the read image data which the calibration unit 62 receives from the scanner 200. Here, the scanner 200 is assumed to read in a reading range that is slightly larger than the sheet size (e.g., 2 mm on the top, bottom, left, and right). As such, the read image 80 has a blank region surrounding a chart image 81.

The calibration unit 62 extracts the chart image 81 from the read image 80, and determines the front, back, and orientation of the chart on the basis of the identification patches in the chart image 81. In the example in FIG. 5, the chart image 81 includes the identification patch 73, and the image can therefore be determined to be the front-side chart 71a (if the identification patch 74 is included, the image is the back-side chart 71b). In addition, because the identification patch 73 is located to the upper-right of the center of the chart, the orientation of the read image 80 can be determined to be in the same positive orientation as the example on the left side of FIG. 4 (if the identification patch 73 is located to the lower-left of the center of the chart, the orientation is opposite).

The calibration unit 62 extracts the edges of the chart image 81 in the read image 80, and measures a length (sheet width) X_{A} in the main scanning direction and a length (sheet length) Y_{B} in the sub scanning direction of the chart image 81. The calibration unit 62 also measures an interval X_{G} between the reference point of the upper-left patch and a left edge, an interval Y_{H} between the reference point of the upper-left patch and an upper edge, an interval X_{K} between the reference point of the upper-right patch and a right edge, an interval Y_{L} between the reference point of the upper-right patch and the upper edge, an interval X_{I} between the reference point of the lower-left patch and the left edge, an interval Y_{J} between the reference point of the lower-left patch and a lower edge, an interval X_{M} between the reference point of the lower-right patch and the right edge, and an interval YN between the reference point of the lower-right patch and the lower edge. Then, on the basis of the measured intervals, the calibration unit 62 calculates an offset of the start-writing position in the main scanning direction and the sub scanning direction, and a magnification in the main scanning direction and the sub scanning direction, as calibration parameters. The calibration unit 62 calculates the offset of the start-writing position in the main scanning direction and the sub scanning direction, and the magnification in the main scanning direction and the sub scanning direction, in the same manner for the read image of the back-side chart 71b.

The calibration unit 62 may calculate a plurality of values for each calibration parameter on the basis of the result of reading a plurality of sheets on which the same chart has been formed, and adopt the average of those values as the calibration parameter values. The calibration parameter values calculated by the calibration unit 62 are output from the controller 50 to the printer control unit 150, and are used to overwrite the setting values held in the setting holding unit 159. As a result, when a subsequent job is executed, misalignment in the image-forming position unique to the printer 100 is resolved, and images are formed at appropriate positions on the sheet.

### 5. Optimizing Reading of Chart

### 5-1. Causes of Reading Abnormalities

As described above, the calibration of the image-forming position relies on the extraction of edges of the chart image in the read image generated by the scanner 200, and the detection of the markers and patches in the chart image. If an abnormality such as a misalignment or skew occurs in the sheet on which the chart image is formed when the scanner 200 reads the sheet, the calibration parameters will not be calculated correctly, and the calibration will fail. For example, if the edge at the front end of the sheet falls outside the range of the read image, the intervals Y_{H} and Y_{L} illustrated in FIG. 5 will be unknown. Likewise, if the edge on the left side of the sheet falls outside the range of the read image, the intervals X_{G} and X illustrated in FIG. 5 will be unknown.

Sheet reading abnormalities can be caused by several factors. One cause is the bundle of sheets set in the document tray 204 not being properly aligned (what is known as “rough setting”). Another cause is the regulating plates 204a not being accurately positioned to contact the side surface of the sheet bundle. Problems with rough setting or the positioning of the regulating plates 204a may cause the sheets conveyed by the ADF 210 to skew, which in turn leads to part of the sheet including the read image falling outside the reading range.

Another cause of sheet reading abnormalities is changes in the mechanical or optical characteristics of the scanner 200 after the product has been shipped. Variations in characteristics specific to individual apparatuses are normally measured at the factory before the product is shipped, and adjustments are made to the reading conditions on the basis of the measurement results to reduce the effects of the variations in characteristics (values for making adjustments are written to the reading condition holding unit 262). However, deterioration of components over time, vibrations, impacts, or excessive loads when transporting the apparatus, and the like may cause the characteristics to deviate from their normal ranges. For example, when transporting the image-forming apparatus 1 due to a move, if the user tries to lift the apparatus by grasping the cover 202 of the scanner 200, an excessive load is placed on the hinge and the components thereof distort mechanically, which can cause the conveyance speed or conveyance angle to shift. Prolonged use of the apparatus also causes changes in properties due to age-related deterioration of components of the ADF 210 and the reading units 220 and 230 (e.g., wear of the conveyance rollers or misalignment of components of the optical system). In addition, sudden changes in temperature and humidity in the installation environment of the image-forming apparatus 1 may cause the components to physically expand and contract. Such changes in the characteristics after the product is shipped are no longer compensated for by adjustments made to the reading conditions before the product was shipped.

If an abnormality in the reading of a sheet is caused by a problem with rough setting or the regulating plates 204a, it may be possible to resolve the abnormality by instructing the user to reload the sheets in the document tray 204 and attempt the reading again, as with the technology disclosed in Japanese Patent Laid-Open No. 2007-329929. However, if the abnormality is caused by a change in the characteristics after the product is shipped, the abnormality will not be resolved even if the user reloads the sheet in the document tray 204 and attempts the reading again.

### 5-2. Readjustment of Reading Conditions

Accordingly, the CPU 51 of the controller 50 functions as the adjustment unit 64, which adjusts at least one reading condition. The adjustment unit 64 provides the user with a UI for calling a reading condition adjustment function, and adjusts the reading conditions in response to a user operation.

In the present embodiment, when the calibration unit 62 calibrates the image-forming position, the adjustment unit 64 determines whether the reading conditions need to be adjusted. Specifically, upon the scanner 200 reading a sheet on which a chart image has been formed, the adjustment unit 64 determines whether the sheet has been read correctly on the basis of the read image, in accordance with at least one determination condition. If the sheet on which the chart image is formed is determined not to have been correctly read by the scanner 200, the adjustment unit 64 outputs a notification prompting the user to adjust at least one reading condition. The notification may be displayed by a display in the operation unit 10, or may be sent to an external apparatus through the communication interface 20. The notification output here may be a notification prompting the user to perform a user operation related to the adjustment function (a first notification).

Typically, the adjustment unit 64 may be capable of adjusting two or more of the reading conditions C1 to C6 described above. In this case, the adjustment unit 64 determines a reading condition, among the two or more reading conditions, that corresponds to the cause of the sheet not being read correctly.

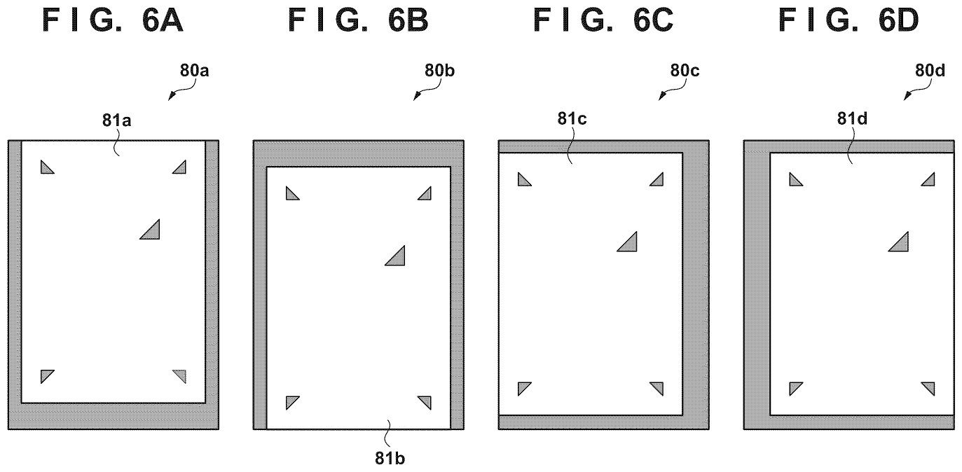

FIGS. 6A to 6D are explanatory diagrams illustrating the determination of an abnormality related to the reading conditions C1 and C2. A read image 80a illustrated in FIG. 6A includes a chart image 81a. The upper edge of the chart image 81a (which can correspond to the front edge in the conveyance direction) is outside the range of the read image 80a. This is an abnormality caused by the start of reading in the sub scanning direction being too late, and can be resolved by setting the start-reading position in the sub scanning direction earlier. A read image 80b illustrated in FIG. 6B includes a chart image 81b. The lower edge of the chart image 81b (which can correspond to the rear edge in the conveyance direction) is outside the range of the read image 80b. This is an abnormality caused by the start of reading in the sub scanning direction being too early, and can be resolved by setting the start-reading position in the sub scanning direction later. A read image 80c illustrated in FIG. 6C includes a chart image 81c. The left edge of the chart image 81c is outside the range of the read image 80c. This is an abnormality caused by the start-reading position in the main scanning direction being too close to the right, and can be resolved by offsetting the start-reading position in the main scanning direction to the left. A read image 80d illustrated in FIG. 6D includes a chart image 81d. The right edge of the chart image 81d is outside the range of the read image 80d. This is an abnormality caused by the start-reading position in the main scanning direction being too close to the left, and can be resolved by offsetting the start-reading position in the main scanning direction to the right.

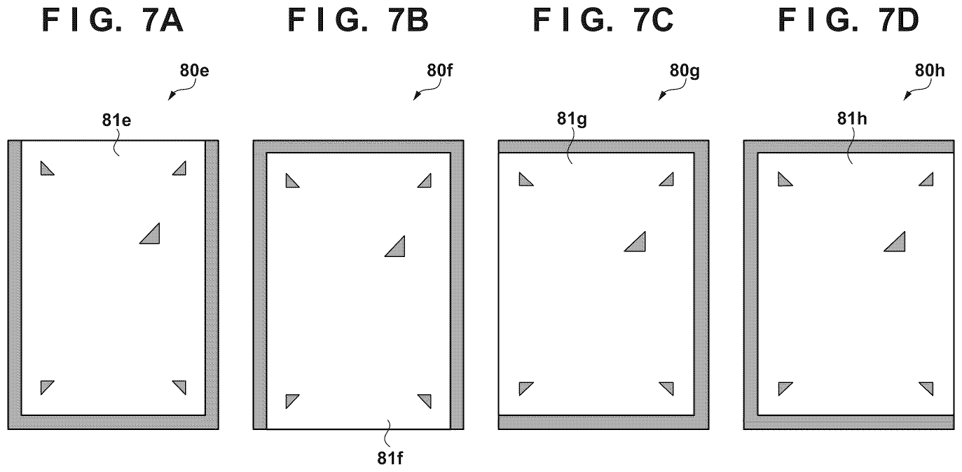

FIGS. 7A to 7D are explanatory diagrams illustrating the determination of an abnormality related to the reading conditions C3 and C4. Comparing the examples in FIGS. 6A to 6D with the examples in FIGS. 7A to 7D, in the four examples in FIGS. 6A to 6D, the aspect ratio of the identification patch, which is a constituent element of the chart image (that is, the ratio of the length of the horizontal side with respect to the length of the vertical side of the right-angle triangle), is equal to 1.0. In contrast, in the two examples illustrated in FIGS. 7A and 7B, the aspect ratio is less than 1.0, i.e., the identification patches are longer in the vertical direction. In the two examples illustrated in FIGS. 7C and 7D, the aspect ratio is greater than 1.0, i.e., the identification patches are longer in the horizontal direction.

A read image 80e illustrated in FIG. 7A includes a chart image 81e. The identification patch in the chart image 81e is longer in the vertical direction, and the upper edge of the chart image 81e is outside the range of the read image 80e. A read image 80f illustrated in FIG. 7B includes a chart image 81f. The identification patch in the chart image 81f is longer in the vertical direction, and the lower edge of the chart image 81f is outside the range of the read image 80f. These are abnormalities caused by the scanning magnification in the sub scanning direction being too high, and can be resolved by reducing the scanning magnification in the sub scanning direction. A read image 80g illustrated in FIG. 7C includes a chart image 81g. The identification patch in the chart image 81g is longer in the horizontal direction, and the left edge of the chart image 81g is outside the range of the read image 80g. A read image 80h illustrated in FIG. 7D includes a chart image 81h. The identification patch in the chart image 81h is longer in the horizontal direction, and the right edge of the chart image 81h is outside the range of the read image 80h. These are abnormalities caused by the scanning magnification in the main scanning direction being too high, and can be resolved by reducing the scanning magnification in the main scanning direction.

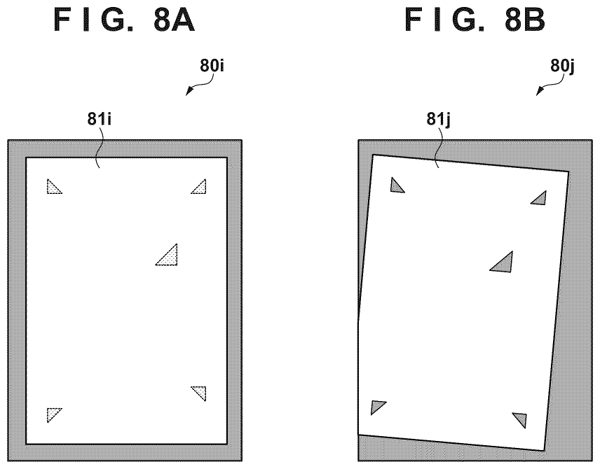

FIGS. 8A and 8B are explanatory diagrams illustrating the determination of an abnormality related to the reading conditions C5 and C6. A read image 80i illustrated in FIG. 8A includes a chart image 81i. Although the chart image 81i includes markers and an identification patch as constituent elements, these constituent elements are blurred due to their low density. This is an abnormality caused by the amount of light with which the sheet was irradiated being inappropriate (e.g., blown-out highlights caused by the light being too strong), and can be resolved by adjusting the amount of light with which the sheet is irradiated. A read image 80j illustrated in FIG. 8B includes a chart image 81j. The chart image 81j is skewed, and the lower-left part thereof is outside the range of the read image 80j. This is an abnormality caused by the skew angle being too great, and can be resolved by adjusting the skew correction amount.

As can be understood from the foregoing descriptions, it is possible to specify a reading condition that would hinder the calibration of the printer 100 (and thus requires adjustment) by determining whether the read image meets determination conditions corresponding to the two or more reading conditions. The causes of the abnormalities in the read image may be complex, and may require a plurality of reading conditions to be adjusted (e.g., abnormalities in both the start-reading position and the scanning magnification or the like).

With the first notification, the adjustment unit 64 may prompt the user to perform a user operation for adjusting a reading condition corresponding to the cause of the sheet not being read correctly (i.e., a reading condition that requires adjustment). For example, the first notification is made on a first notification screen displayed by the display in the operation unit 10 or an external apparatus. The first notification screen indicates to the user which reading condition requires adjustment. The first notification screen may further include a display region that at least partially displays the read image (a preview region). In the preview region, the part in the read image where the abnormality has been detected may be displayed in an enlarged or highlighted manner. The first notification screen may include a button for calling an adjustment screen for adjusting the reading condition corresponding to the cause of the sheet not being read correctly.

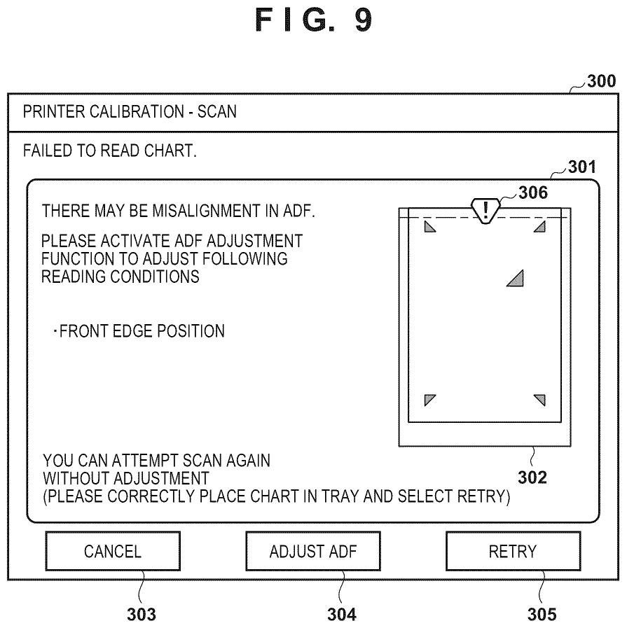

FIG. 9 is an explanatory diagram illustrating an example of a configuration of a first notification screen 300. The first notification screen 300 may be displayed by the display when an abnormality is determined to be present in the start-reading position in the sub scanning direction (also called a “front edge position”). The first notification screen 300 includes a message region 301, a preview region 302 in the message region 301, a cancel button 303, an adjustment button 304, and a retry button 305.

A message prompting the user to adjust the front edge position is displayed in the message region 301. Meanwhile, a preview of the read image is displayed in the preview region 302, and an object 306 indicating a warning that an abnormality has occurred is added to the read image corresponding to the front edge position and to the upper edge of the chart image. The user can know which reading condition should be adjusted from the message displayed in the message region 301. The user can also visually determine how the specified reading condition should be adjusted from the details displayed in the preview region 302.

When the user operates the cancel button 303, the adjustment unit 64 closes the first notification screen 300 and stops the processing. The adjustment button 304 is a button for calling an ADF adjustment screen 310, which will be described next. When the user operates the adjustment button 304, the adjustment unit 64 displays the ADF adjustment screen 310 on the display. Additionally, by operating the retry button 305, the user can reload the sheet on which the chart image is formed in the document tray 204 correctly, and attempt the reading again, without adjusting the reading conditions.

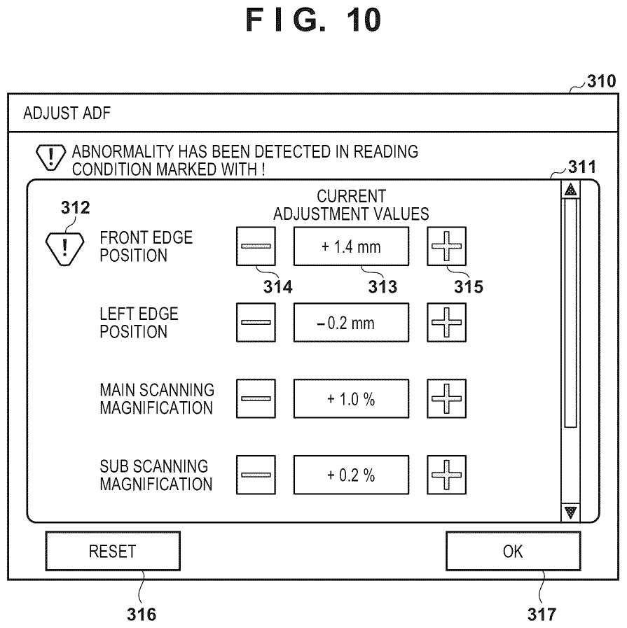

FIG. 10 is an explanatory diagram illustrating an example of a configuration of the ADF adjustment screen 310. The ADF adjustment screen 310 includes an adjustment input region 311, a reset button 316, and an OK button 317. The reading conditions that can be adjusted by the adjustment unit 64 are listed in the adjustment input region 311, and a UI for accepting the input of an adjustment value is provided for each reading condition. The user can display the UI of the desired reading condition on the screen by scrolling the adjustment input region 311 up and down. In the example in FIG. 10, an object 312 that warns of the occurrence of an abnormality is added to the “front edge position” corresponding to the reading condition C2. An input field 313 is a field for accepting the input of the adjustment value for the “front edge position”. A minus button 314 is a button for lowering the adjustment value of the “front edge position”. A plus button 315 is a button for raising the adjustment value of the “front edge position”. By operating the input field 313, the minus button 314, or the plus button 315, the user can adjust the start-reading position in the sub scanning direction such that the front edge position of the chart image falls within the range of the read image. The other reading conditions may be adjusted in the same manner.

When the user operates the reset button 316, the adjustment unit 64 cancels unsaved changes to the adjustment values on the ADF adjustment screen 310 and displays the original adjustment values in the respective input fields. When the user operates the OK button 317, the adjustment unit 64 obtains the adjustment values changed by the user, and updates the reading conditions held by the reading condition holding unit 262 of the scanner 200 on the basis of the obtained adjustment values.

Providing a UI for making it easy to access the ADF adjustment screen 310 from the first notification screen 300 as in the practical example illustrated here enables the user to adjust the reading conditions of the scanner 200 when desired during tasks for calibrating the image-forming position.

In one practical example, the determination conditions for determining an abnormality in the reading of a sheet may include a determination condition of a first type for determining an abnormality with respect to a reading condition that can be adjusted in accordance with a user operation, and a determination condition of a second type that is different from the determination condition of the first type. The determination condition of the second type may be a condition for determining an abnormality that cannot be resolved by adjustments made through user operations. If the determination condition of the first type is met, the adjustment unit 64 outputs the aforementioned first notification. On the other hand, if the determination condition of the second type is met, the adjustment unit 64 outputs a second notification prompting the user to request a third party (e.g., a maintenance worker) to adjust the scanner 200.

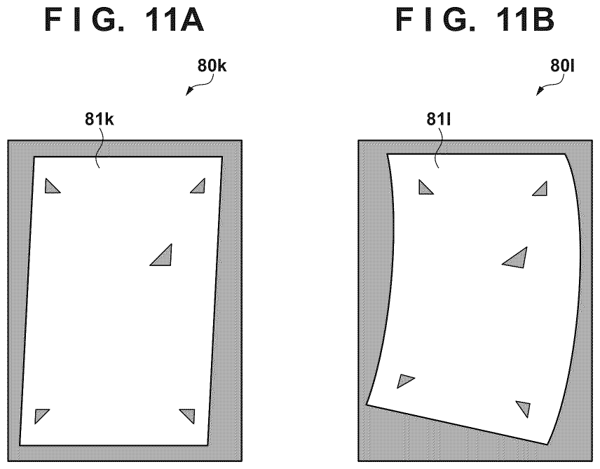

FIGS. 11A and 11B are explanatory diagrams illustrating the determination of an abnormality in a chart image that cannot be resolved by adjustments made through user operations. A read image 80k illustrated in FIG. 11A includes a chart image 81k. The shape of the chart image 81k is a parallelogram, and the two longer sides are tilted relative to the conveyance direction of the sheet. A read image 801 illustrated in FIG. 11B includes a chart image 811. The shape of the chart image 811 is a curved band, and the two longer sides form arcs. Such an irregular shape is mainly due to physical distortion of the components of the ADF 210 (e.g., hinges), and suggests that documents are not being conveyed straight along the conveyance path D2. In this case, the abnormality cannot be resolved by adjusting the reading conditions in accordance with user operations, and it is therefore desirable to request a maintenance worker to make more specialized adjustments.

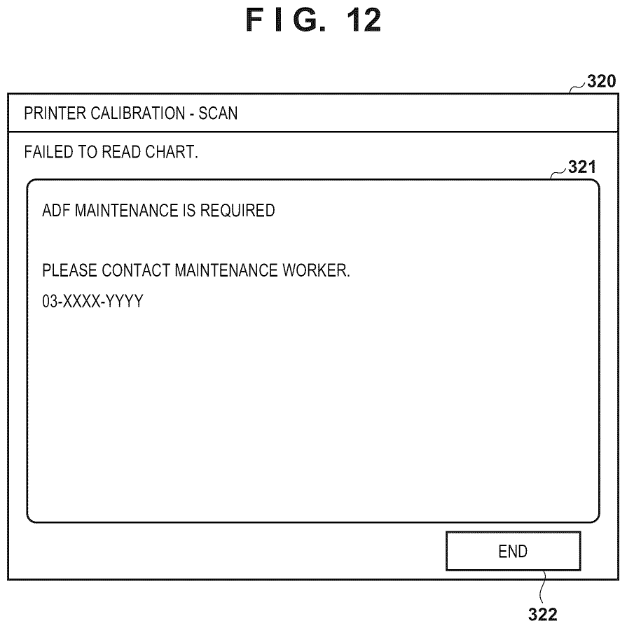

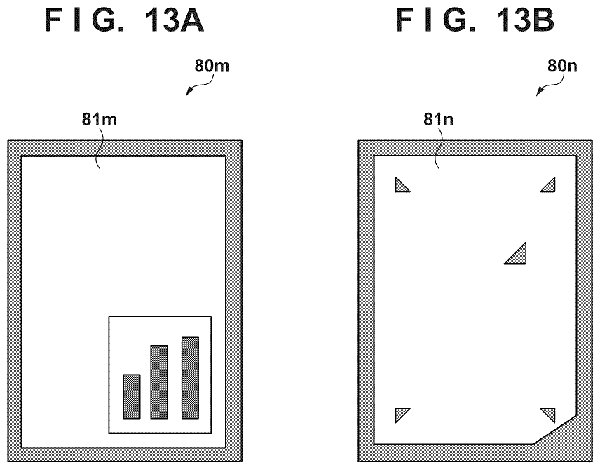

The second notification may be made on a second notification screen displayed by the display in the operation unit 10 or an external apparatus, for example. FIG. 12 is an explanatory diagram illustrating an example of a configuration of a second notification screen 320. The second notification screen 320 may be displayed by the display when the determination condition of the second type is determined to be met. The second notification screen 320 includes a message region 321 and an end button 322. A message indicating that the ADF 210 requires maintenance, as well as a message prompting the user to contact a maintenance worker, are displayed in the message region 321. After confirming this message, the user contacts the maintenance worker through a suitable method, and closes the second notification screen 320 by operating the end button 322. Although not illustrated in FIG. 12, a code identifying the cause of the abnormality (to be sent to the maintenance worker) may be displayed on the second notification screen 320.

The determination conditions of the first type can include the following conditions, for example:

### (1) First Determination Conditions:

conditions related to abnormalities in the position of the sheet in the read image (see FIGS. 6A to 6D)
if the first determination condition is met, prompt the user to adjust the start-reading position in the main scanning direction or the sub scanning direction in the scanner 200

### (2) Second Determination Conditions:

conditions related to the aspect ratio of the constituent elements of the chart image (see FIGS. 7A to 7D)
if the second determination condition is met, prompt the user to adjust the scanning magnification in the main scanning direction or the sub scanning direction in the scanner 200

### (3) Third Determination Conditions:

conditions related to the density of the constituent elements of the chart image (see FIG. 8A)
if the third determination condition is met, prompt the user to adjust the amount of light with which the sheet is irradiated

### (4) Fourth Determination Conditions:

conditions related to the slant of the sheet in the read image (see FIG. 8B)
if the fourth determination condition is met, prompt the user to adjust the skew correction amount in the ADF 210

The determination conditions of the second type can include the following conditions, for example:

### (5) Fifth Determination Conditions:

conditions related to the shape of the sheet in the read image (see FIGS. 11A and 11B)
if the fifth determination condition is met, prompt the user to request a third party to adjust the scanner 200

In a practical example, the adjustment unit 64 may further determine the likelihood that a mistake has been made during work. FIGS. 13A and 13B are explanatory diagrams illustrating determination of an abnormality in a chart image caused by a mistake made during work. A read image 80m illustrated in FIG. 13A includes a sheet image 81m. The sheet image 81m does not include the markers and identification patches that are the constituent elements of the chart. The read image 80m is therefore assumed to be the result of reading of an incorrect sheet that was not intended to be read. A read image 80n illustrated in FIG. 13B includes a chart image 81n. The chart image 81n is a pentagon rather than a rectangle, and a part on the lower-right of the sheet is missing. The read image 80n is therefore assumed to be the result of reading of a sheet which is partially folded. If such a mistake during work is determined to have occurred, the adjustment unit 64 outputs a third notification prompting the user to re-set the sheet on which the chart image is formed correctly in the document tray 204 and attempt the reading again.

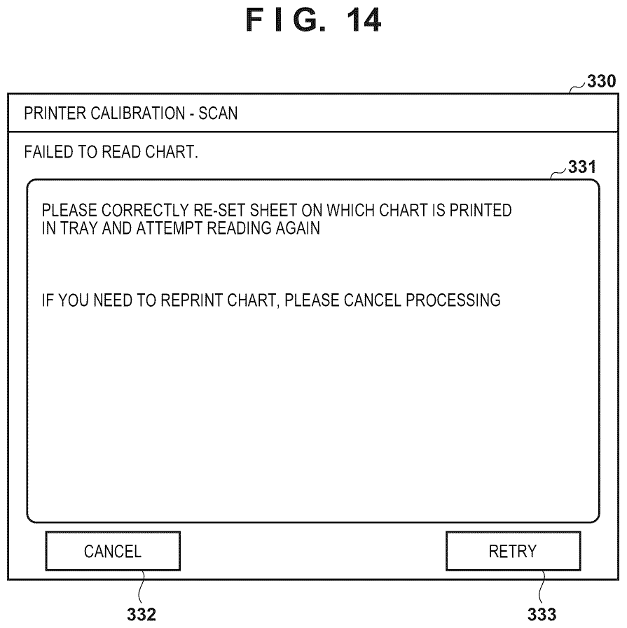

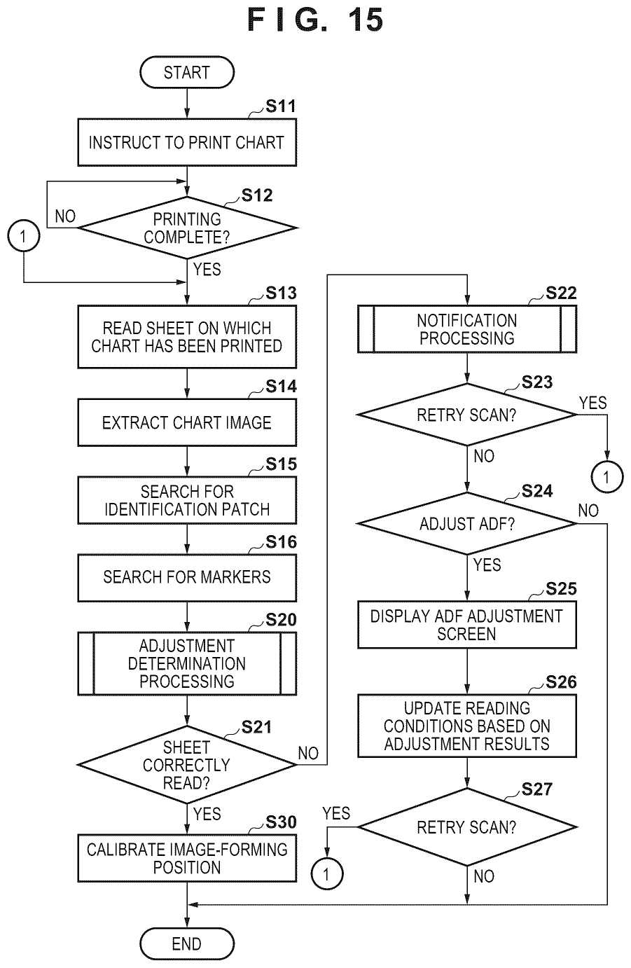

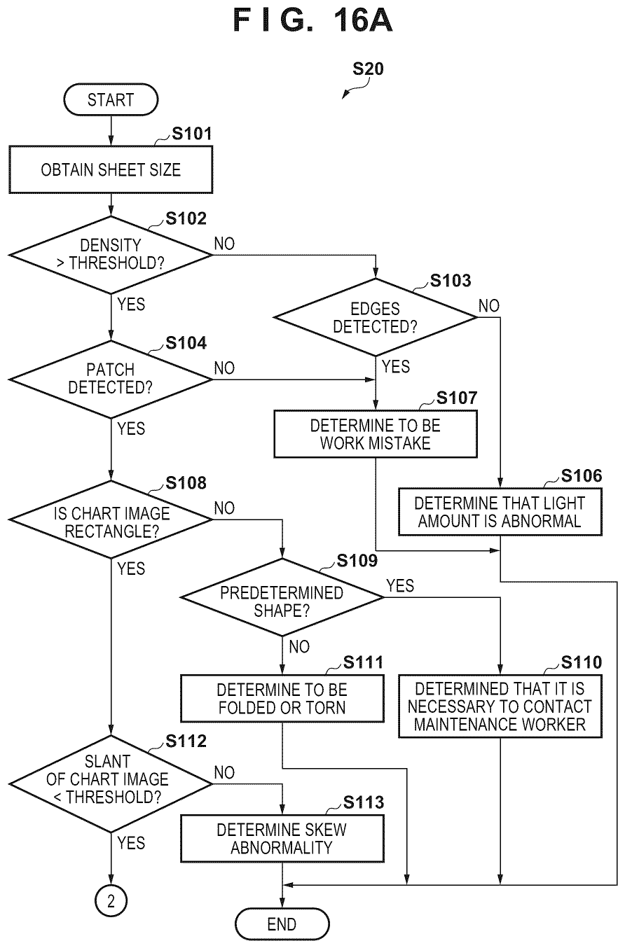

The third notification may be made on a third notification screen displayed by the display in the operation unit 10 or an external apparatus, for example. FIG. 14 is an explanatory diagram illustrating an example of a configuration of a third notification screen 330. The third notification screen 330 includes a message region 331, a cancel button 332, and a retry button 333. A message prompting the user to attempt to read the sheet again is displayed in the message region 331. When the user operates the cancel button 332, the adjustment unit 64 closes the third notification screen 330 and stops the processing. The user may cancel the processing and start over from the printing of the chart. When the user re-sets the sheet on which the chart image is formed correctly in the document tray 204 and operates the retry button 333, the sheet is conveyed again by the ADF 210, and a read image including the chart image is generated.

If none of the determination conditions mentioned above are met and the sheet is correctly read by the scanner 200, the adjustment unit 64 causes the calibration unit 62 to calibrate the printer 100 on the basis of the chart image included in the read image.

### 6. Flow of Processing

This section will describe several examples of flows of processing that can be executed by the image-forming apparatus 1 in connection with the adjustment of the reading conditions, with reference to the flowcharts in FIGS. 15 to 17. Note that in the following descriptions, the processing steps will be indicated by an “S”.

### 6-1. Calibration Processing

FIG. 15 is a flowchart illustrating an example of the overall flow of calibration processing according to an embodiment. The calibration processing of FIG. 15 is implemented by, for example, the CPU 51 of the controller 50 executing a computer program loaded into the RAM 53 from the ROM 52.

First, in step S11, through the printer I/F 56, the calibration unit 62 instructs the printer control unit 150 to print a chart. Here, the configuration may be such that the user can designate the number of sheets on which the chart is to be printed, and from which cassette the sheets are to be supplied. The printer control unit 150 controls the printer 100 to print a chart on the designated number of sheets supplied from the designated cassette. Next, in step S12, the calibration unit 62 stands by until the printing of the chart by the printer 100 is complete. The sequence moves to step S13 once the printing of the chart is complete.

In step S13, the calibration unit 62 instructs the user to set the sheets on which the chart has been printed in the document tray 204 and start the reading. When the user performs an operation for starting the reading, the sheets are conveyed one by one from the document tray 204 by the ADF 210, the sheets are read by the scanner 200, and read image data is generated. The calibration unit 62 receives the read image data from the scanner control unit 250.

In step S14, the calibration unit 62 extracts the chart images from the read images. Next, in step S15, the calibration unit 62 searches for the identification patch in the chart images, and determines the front, back, and orientation of the chart images on the basis of the position and the direction of the inclined side of the detected identification patch. Next, in step S16, the calibration unit 62 searches for the markers in the chart images, and detects the four markers present on each surface.

Next, in step S20, the calibration unit 62 calls the adjustment unit 64, and causes it to perform, on the basis of the results of the analysis on the read images performed in steps S14 to S16, adjustment determination processing for determining the need to adjust the reading conditions. An example of a flow of the adjustment determination processing executed by the adjustment unit 64 will be described in detail below. The processing thereafter branches depending on the result of the adjustment determination processing. The sequence moves to step S30 when it is determined that the sheets have been read correctly as a result of the adjustment determination processing. Meanwhile, the sequence moves to step S22 when it is determined that an abnormality has occurred in the reading of the sheets.

In step S22, the adjustment unit 64 executes notification processing in accordance with the type of the abnormality determined to have occurred in the adjustment determination processing. An example of a flow of the notification processing executed by the adjustment unit 64 will be described in detail below. The processing that follows thereafter branches depending on the option selected by the user that has received the notification.

If the user operates the retry button 305 in the first notification screen 300, or operates the retry button 333 in the third notification screen 330 (step S23—YES), the sequence returns to S13, and the sheets are read again by the scanner 200.

If the user operates the adjustment button 304 in the first notification screen 300 (step S23—NO, step S24—YES), the sequence moves to step S25. In step S25, the adjustment unit 64 displays the ADF adjustment screen 310 on the display. Next, when the adjustment of the reading conditions by the user is complete, in step S26, the adjustment unit 64 updates the reading conditions held by the reading condition holding unit 262 of the scanner 200 on the basis of the adjustment results. The adjustment unit 64 closes the ADF adjustment screen 310 and displays the first notification screen 300 on the display again. Then, when the user operates the retry button 305 in the first notification screen 300 (step S27—YES), the sequence returns to step S13, and the sheets are read by the scanner 200 in accordance with the updated reading conditions.

If it is determined that the sheets have been read correctly in the adjustment determination processing performed in step S20, in step S30, the calibration unit 62 calibrates the image-forming position of the printer 100 on the basis of the edges of the chart images extracted in step S14 and the positions of the reference points of the markers detected in step S16.

### 6-2. Adjustment Determination Processing

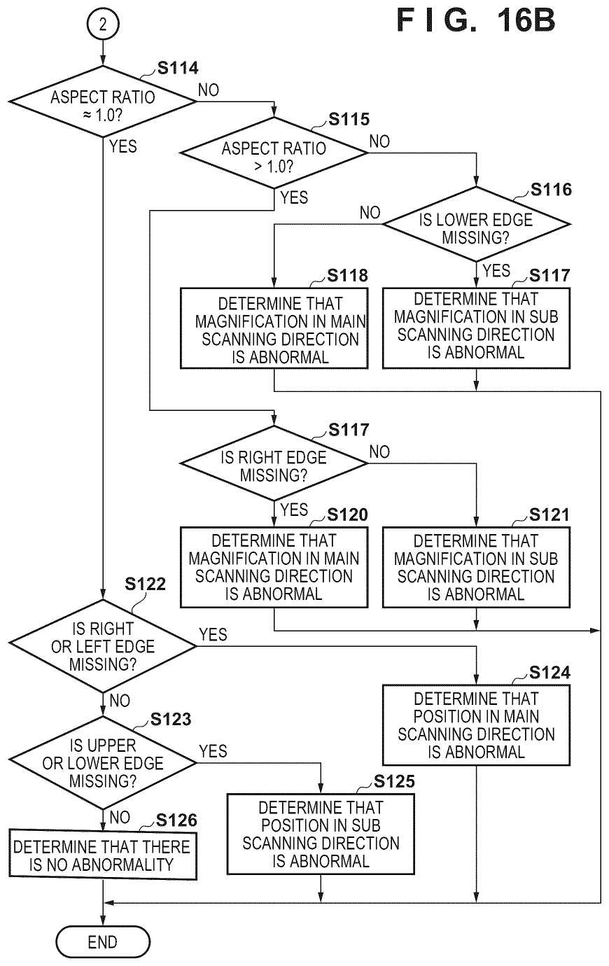

FIGS. 16A and 16B are flowcharts illustrating, in detail, an example of a flow of the adjustment determination processing executed in step S20 of FIG. 15. The adjustment determination processing of FIGS. 16A and 16B is implemented by, for example, the CPU 51 of the controller 50 executing a computer program loaded into the RAM 53 from the ROM 52.

First, in step S101, the adjustment unit 64 obtains the sheet size. The sheet size may, for example, be determined on the basis of the sensor signals from the width sensor 204b and the separation sensor 213, obtained from sheet information of the cassette designated in step S11 in FIG. 15, or determined on the basis of the chart image extracted in step S14.

Next, in step S102, the adjustment unit 64 determines whether the density of the constituent elements detected in the chart image exceeds a predetermined density threshold. If the density of the constituent elements is below the density threshold, in step S103, the adjustment unit 64 further determines whether the edges of the chart image corresponding to the sheet size have been detected at the appropriate positions. Meanwhile, if the density of the constituent elements exceeds the density threshold, in step S104, the adjustment unit 64 determines whether the identification patch has been detected in the chart image.

If the density of the constituent elements of the chart is below the density threshold and the edges of the chart image are not detected at the appropriate positions, in step S106, the adjustment unit 64 determines that the amount of light with which the sheet has been irradiated is abnormal (the third determination condition).

If the density of the constituent elements of the chart is below the density threshold and the edges of the chart image are detected at the appropriate positions, in step S107, the adjustment unit 64 determines that a mistake has been made during work (e.g., a blank sheet has been read). If the density of the constituent elements of the chart exceeds the density threshold and no identification patch is detected in the chart image, in step S107, the adjustment unit 64 determines that a mistake has been made during work (e.g., the wrong sheet has been read).

Meanwhile, if the density is correct and the identification patch is detected, in step S108, the adjustment unit 64 determines whether the chart image extracted from the read image is a rectangle. If the chart image is not a rectangle, in step S109, the adjustment unit 64 further determines whether the shape of the chart image is a special shape, such as those described with reference to FIGS. 11A and 11B. For example, if the shape of the chart image is a parallelogram or a curved band, in step S110, the adjustment unit 64 determines that it is necessary for the user to contact a maintenance worker (the fifth determination condition). Meanwhile, if the shape of the chart image is not a rectangle and does not correspond to the special shape mentioned above, in step S111, the adjustment unit 64 determines that the sheet is folded or torn.

If the chart image is determined to be a rectangle in step S108, in step S112, the adjustment unit 64 compares the slant of the chart image with a predetermined angle threshold. If the slant of the chart image is greater than the angle threshold, in step S113, the adjustment unit 64 determines that there is an abnormality in terms of skew (the fourth determination condition).

If the slant of the chart image is less than the angle threshold, in step S114, the adjustment unit 64 determines whether the aspect ratio of the identification patch detected in the chart image is approximately equal to 1.0. If the aspect ratio of the identification patch is not approximately equal to 1.0, an abnormality is determined to be present in the scanning magnification in one or both of the main scanning direction and the sub scanning direction (the second determination condition). For example, if the aspect ratio of the identification patch is less than 1.0 (step S115—NO) and the lower edge of the chart image is missing (step S116—YES), the adjustment unit 64 determines in S117 that the scanning magnification in the sub scanning direction is abnormal. Similarly, if the aspect ratio of the identification patch is less than 1.0 (step S115—NO) and the lower edge of the chart image is not missing (step S116—NO), the adjustment unit 64 determines in S118 that the scanning magnification in the main scanning direction is abnormal. If the aspect ratio of the identification patch is greater than 1.0 (step S115—YES) and the right edge of the chart image is missing (step S117—YES), the adjustment unit 64 determines in S120 that the scanning magnification in the main scanning direction is abnormal. If the aspect ratio of the identification patch is greater than 1.0 (step S115—YES) and the right edge of the chart image is not missing (step S117—NO), the adjustment unit 64 determines in S121 that the scanning magnification in the sub scanning direction is abnormal.

If the aspect ratio of the identification patch is approximately equal to 1.0, in step S122, the adjustment unit 64 determines whether the left or right edge of the chart image is missing. In step S123, the adjustment unit 64 determines whether the upper or lower edge of the chart image is missing. If any edge is missing, the start-reading position is determined to be abnormal in the corresponding direction, of the main scanning direction and the sub scanning direction (the first determination condition). For example, if the right or left edge of the chart image is missing (S122—YES), the adjustment unit 64 determines in S124 that the start-reading position in the main scanning direction is abnormal. If the upper or lower edge of the chart image is missing (step S123—YES), the adjustment unit 64 determines in step S125 that the start-reading position in the sub scanning direction is abnormal.

If none of the four edges of the chart image are missing from the read image (step S122—NO, step S123—NO), in step S126, the adjustment unit 64 determines that there is no abnormality in the reading of the sheet.

The adjustment unit 64 records, in a memory, what type of abnormality has been determined to be present (or absent) in each determination step. The adjustment determination processing in FIGS. 16A and 16B then ends.

### 6-3. Notification Processing

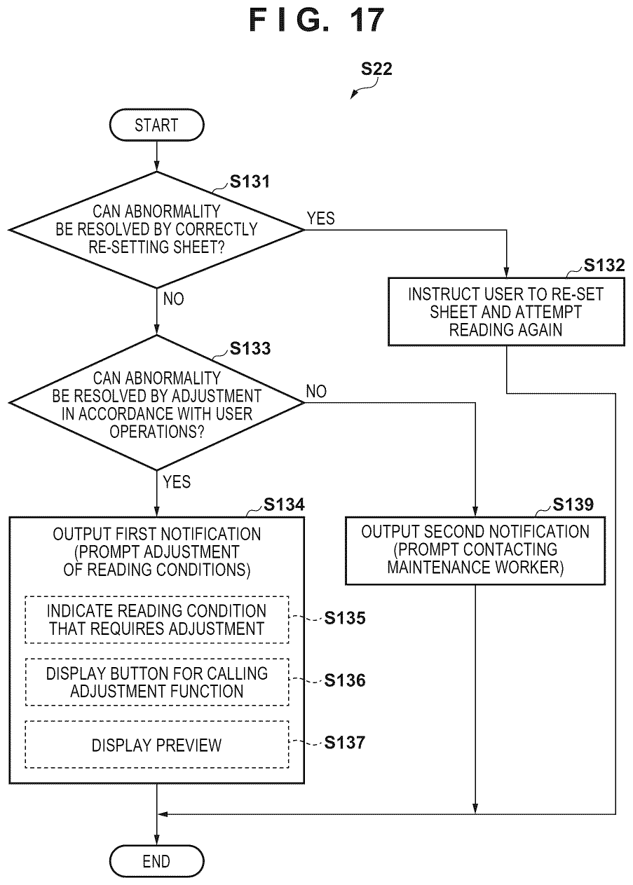

FIG. 17 is a flowchart illustrating, in detail, an example of a flow of the notification processing executed in step S22 of FIG. 15. The notification processing of FIG. 17 is implemented by, for example, the CPU 51 of the controller 50 executing a computer program loaded into the RAM 53 from the ROM 52.

First, in step S131, the adjustment unit 64 determines, on the basis of the result of the adjustment determination processing, whether the abnormality can be resolved by the user correctly re-setting the sheet. If it is determined that the abnormality can be resolved by re-setting the sheet, the sequence moves to step S132. Meanwhile, if it is determined that the abnormality will not be resolved by re-setting the sheet, the sequence moves to step S133.

In step S132, the adjustment unit 64 displays the third notification screen 330 described above on the display, and instructs the user to correctly re-set the sheet on which the chart is printed in the document tray 204 and attempt the reading again.

In step S133, the adjustment unit 64 determines whether the abnormality can be resolved by adjusting a reading condition in accordance with user operations. If it is determined that the abnormality can be resolved by adjusting a reading condition in accordance with user operations (e.g., if the read image satisfies a determination condition of the first type), the sequence moves to step S134. Meanwhile, if it is determined that the abnormality will not be resolved by adjusting a reading condition in accordance with user operations (e.g., if the read image satisfies a determination condition of the second type), the sequence moves to step S139.

In step S134, the adjustment unit 64 outputs a first notification for prompting the user to adjust at least one reading condition. Here, output of the first notification may include indicating a reading condition that requires adjustment to the user on the screen in step S135. The output of the first notification may also include displaying a button for calling the adjustment function on the screen in step S136. The output of the first notification may also include displaying a preview of the read image on the screen in step S137.

In step S139, the adjustment unit 64 outputs the second notification for prompting the user to contact a maintenance worker to request for adjustment of the scanner 200.

Although this section has described determination conditions for determining an abnormality in reading of sheets along with specific examples of the determination and notification sequences, the technology according to the present disclosure is not limited to the examples described above. For example, though there has been described a technique for determining whether the aspect ratio of the identification patch is approximately equal to 1.0, which is a single reference value, in connection with the second determination condition, as another example, it is also possible to determine whether the aspect ratio of the identification patch falls within a range defined by a predetermined upper limit and a predetermined lower limit. Moreover, for example, if an abnormality is determined to have occurred in reading a sheet, the adjustment unit 64 may instruct the user to attempt sheet reading at least one more time before prompting the user to adjust the reading conditions.

### 7. Conclusion

Thus far, various embodiments and practical examples of the technology according to the present disclosure have been described with reference to FIGS. 1 to 17. In the foregoing embodiments, a control unit of an image-forming apparatus outputs, when it is determined that reading of a sheet, on which a chart image for calibrating an image-forming unit is formed, has not been performed correctly, a notification prompting a user to adjust at least one reading condition of a reading unit. This facilitates optimization of sheet reading conditions used to calibrate the image-forming unit. Accordingly, even if the characteristics of the reading unit deviate from a normal range after product shipment, parameter values for the calibration will be obtained under appropriate reading conditions and, as a result, the calibration of the image-forming unit will be prevented from failing.

In the foregoing embodiments, the image-forming apparatus is capable of adjusting at least one reading condition in response to a user operation, and the notification includes a first notification prompting the user to perform a user operation for adjusting the reading condition. In this case, when an attempt is made to read a sheet on which a chart image is formed, it is possible to direct a user to perform a user operation for adjusting the reading conditions in a timely manner.

In the foregoing embodiments, the first notification is output in a case where the read image satisfies a determination condition of a first type for determining an abnormality with respect to a reading condition that can be adjusted in accordance with a user operation. On the other hand, a second notification prompting the user to request a third party to adjust the reading unit is output in a case where the read image satisfies a determination condition of a second type for determining an abnormality that cannot be resolved by an adjustment made in accordance with a user operation. According to this configuration, the user can be prompted to take appropriate actions according to what type of abnormality is detected, which makes it possible to reduce the time taken to resolve the abnormality and improve the productivity of the user.

Note that, in one variation, the technology according to the present disclosure may be applied to adjustment of a reading condition in reading of sheets (on which the chart image is formed) placed on a document platform instead of the adjustment of the reading conditions in flow reading using an ADF. In another variation, the technology according to the present disclosure may be applied to adjustment of a reading condition in reading of a chart for other purposes, such as color calibration in a color printer, instead of the reading of the chart for calibrating the image-forming position of the printer.

### 8. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-105475, filed on Jun. 28, 2024 which is hereby incorporated by reference herein in its entirety.

What is claimed is:

1. An image-forming apparatus comprising:
an image-forming unit;
a calibration unit configured to execute calibration of the image-forming unit on the basis of a chart image formed by the image-forming unit;
a reading unit configured to generate a read image including the chart image by reading, according to at least one reading condition, a sheet on which the chart image is formed while conveying the sheet along a conveyance path; and
a control unit configured to determine, on the basis of the read image, whether the sheet has been correctly read by the reading unit,
wherein the control unit is configured to output a notification prompting a user to adjust the at least one reading condition in a case where it is determined that the sheet has not been correctly read by the reading unit.

2. The image-forming apparatus according to claim 1,
wherein the control unit is capable of adjusting the at least one reading condition in accordance with a user operation, and
the notification includes a first notification prompting the user to perform the user operation.

3. The image-forming apparatus according to claim 2,
wherein the control unit is capable of adjusting two or more reading conditions, and
the first notification includes indicating, to the user, a reading condition, among the two or more reading conditions, that corresponds to a cause of the sheet not being read correctly.

4. The image-forming apparatus according to claim 3,
wherein the two or more reading conditions are two or more of the following:
a start-reading position in a main scanning direction perpendicular to a conveyance direction of the sheet;
a start-reading position in a sub scanning direction parallel to the conveyance direction;
a scanning magnification in the main scanning direction;
a scanning magnification in the sub scanning direction;
an amount of light with which the sheet is irradiated; and
a skew correction amount.

5. The image-forming apparatus according to claim 2,
wherein the first notification is displayed on a first notification screen, and
the first notification screen includes a display region that displays the read image at least partially.

6. The image-forming apparatus according to claim 2,
wherein the first notification is displayed on a first notification screen, and
the first notification screen includes a button for calling an adjustment screen for adjusting the at least one reading condition.

7. The image-forming apparatus according to claim 2,
wherein the control unit is configured to:
output the first notification, in a case where the read image satisfies a determination condition of a first type for determining an abnormality with respect to a reading condition that can be adjusted in accordance with a user operation; and
output a second notification prompting the user to request a third party to adjust the reading unit, in a case where the read image satisfies a determination condition of a second type for determining an abnormality that cannot be resolved by an adjustment made in accordance with a user operation.

8. The image-forming apparatus according to claim 7,
wherein the determination condition of the first type includes a first determination condition related to an abnormality in a position of the sheet in the read image, and
the first notification output in a case where the sheet is determined not to have been correctly read in accordance with the first determination condition prompts the user to adjust a start-reading position of the reading unit.

9. The image-forming apparatus according to claim 7,
wherein the determination condition of the first type includes a second determination condition related to an aspect ratio of constituent elements of the chart image included in the read image, and
the first notification output in a case where the sheet is determined not to have been correctly read in accordance with the second determination condition prompts the user to adjust a scanning magnification of the reading unit.

10. The image-forming apparatus according to claim 7,
wherein the determination condition of the first type includes a third determination condition related to density of the read image, and
the first notification output in a case where the sheet is determined not to have been correctly read in accordance with the third determination condition prompts the user to adjust an amount of light with which the sheet is irradiated by the reading unit.

11. The image-forming apparatus according to claim 7,
wherein the determination condition of the first type includes a fourth determination condition related to a slant of the sheet in the read image, and
the first notification output in a case where the sheet is determined not to have been correctly read in accordance with the fourth determination condition prompts the user to adjust a skew correction amount of the reading unit.

12. The image-forming apparatus according to claim 7,
wherein the determination condition of the second type includes a fifth determination condition related to a shape of the sheet in the read image.

13. The image-forming apparatus according to claim 1,
wherein the control unit is configured to cause the calibration unit to execute the calibration of the image-forming unit based on the chart image included in the read image in a case where it is determined that the sheet has been correctly read by the reading unit.
